(19) United States
(12) Patent Application Publication
(10) Pub. No.: US 2026/0012879 A1
(43) Pub. Date: Jan. 8, 2026

(54) TIME TRANSFER ENHANCEMENTS

(71) Applicant: QUALCOMM Incorporated, San Diego, CA (US)

(72) Inventors: Arun Kumar Sharma TANDRA, Hyderabad (IN); Naveen Kumar ARAVAPALLI, Hyderabad (IN)

(21) Appl. No.: 18/763,957

(22) Filed: Jul. 3, 2024

(51) Int. Cl. H04W 48/08; H04W 48/16; H04W 64/00; H04W 88/06

(52) U.S. Cl. CPC H04W 48/08; H04W 48/16; H04W 64/006; H04W 88/06

(57) ABSTRACT

Aspects presented herein may enable a user equipment (UE) to obtain and utilize crowdsourced system information block (SIB) data from a server do determine whether to decode SIB to improve the overall performance of positioning and power consumption. In one aspect, a UE receives, from a network entity, a portion of information related to a SIB based on a position of the UE, where the SIB is associated with a time transfer, where the information related to the SIB includes at least one of: an availability of the SIB, a type of the SIB, a transmitting interval of the SIB, a time uncertainty (TUNC) associated with the SIB, a time error associated with the SIB, or a reliability of a serving cell timing. The UE decodes the SIB based on the portion of the information.

### TECHNICAL FIELD

The present disclosure relates generally to communication systems, and more particularly, to wireless communication involving positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus receives, from a network entity, a portion of information related to a system information block (SIB) based on a position of a user equipment (UE), where the SIB is associated with a time transfer, where the information related to the SIB includes at least one of: an availability of the SIB, a type of the SIB, a transmitting interval of the SIB, a time uncertainty (TUNC) associated with the SIB, a time error associated with the SIB, or a reliability of a serving cell timing. The apparatus decodes the SIB based on the portion of the information.

In an aspect of the disclosure, a method, a computer-readable medium, and an apparatus are provided. The apparatus receives, from a first set of UEs, (1) information related to a SIB, (2) position information of the first set of UEs, and (3) time information of the first set of UEs, where the SIB is associated with a time transfer, where the information related to the SIB includes at least one of: an availability of the SIB, a type of the SIB, a transmitting interval of the SIB, a TUNC associated with the SIB, a time error associated with the SIB, or a reliability of a serving cell timing. The apparatus transmits, to a second UE based on the information related to the SIB, the position information, and the time information, a portion of the information related to the SIB based on a position of the second UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of global navigation satellite system (GNSS) positioning in accordance with various aspects of the present disclosure.

FIG. 6 is a communication flow illustrating an example of a network entity crowdsourcing system information block type 9 (SIB9) and/or system information block type 16 (SIB16) related information in accordance with various aspects of the present disclosure.

FIG. 7 is a diagram illustrating an example of configuring a UE to wake-up (from a sleep/power saving mode) based on the availability of SIB9/SIB16 in accordance with various aspects of the present disclosure.

FIG. 8 is a flowchart of a method of wireless communication.

FIG. 9 is a flowchart of a method of wireless communication.

FIG. 10 is a diagram illustrating an example of a hardware implementation for an example apparatus and/or network entity.

FIG. 11 is a flowchart of a method of wireless communication.

FIG. 12 is a diagram illustrating an example of a hardware implementation for an example network entity.

### DETAILED DESCRIPTION

Aspects presented herein may improve the overall positioning latency and performance at global navigation satellite system (GNSS) devices by enhancing the accuracy, the reliability, and the availability of system information block type 9 (SIB9) and/or system information block type 16 (SIB16) (collectively “SIB9/SIB16” hereafter). Aspects presented herein provide techniques for crowdsourcing SIB9/SIB16 data and utilization of the crowdsourced SIB9/SIB16 data. For example, in one aspect of the present disclosure, a server may be configured to collect (e.g., crowdsource) SIB9/SIB16 related information from a first group of user equipments (UEs), where the SIB9/SIB16 related information may include SIB9/SIB16 availability, transmission type (e.g., broadcast, dedicated messaging), transmission interval, time uncertainty, time error, and/or reliability (of the current serving cell timing), etc. The first group of UEs may be configured to tag (e.g., include) SIB9/SIB16 related information they obtained with their current GNSS locations and/or GNSS time. Then, the server may provide the collected SIB9/SIB16 related information (which may be referred to as the “crowdsourced information” or the “crowdsourced SIB9/SIB16 information” to a second group of UEs, where the second group of UEs may decode SIB9/SIB16 or make SIB9/SIB16 decoding decisions based on the crowdsourced information. For example, the second group of UEs may make use of crowdsourced information from the server to check the availability of SIB9/SIB16 and make decision a priori whether to decode SIB9/SIB16 content or not. Aspects presented herein also enable GNSS devices to select cells for performing GNSS fix wakes up. As SIB9/SIB16 may provide signification power advantages and performance (e.g., faster time-to-fix (TTF)) in GNSS space vehicle (SV) acquisition (e.g., avoids time decoding), which may be crucial for asset trackers/Internet of Things (IoT) devices, GNSS devices may be configured to schedule GNSS fix wake-ups just when they are in the vicinity of cell(s) with SIB9/SIB16 availability (e.g., obtained from the crowdsourced information) to save power. In some examples, GNSS devices may also be configured to obtain SIB9/SIB16 from alternate sources, such as decoding SIB9/SIB16 from neighboring cell(s), from other carriers, and/or from other WWAN technologies.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

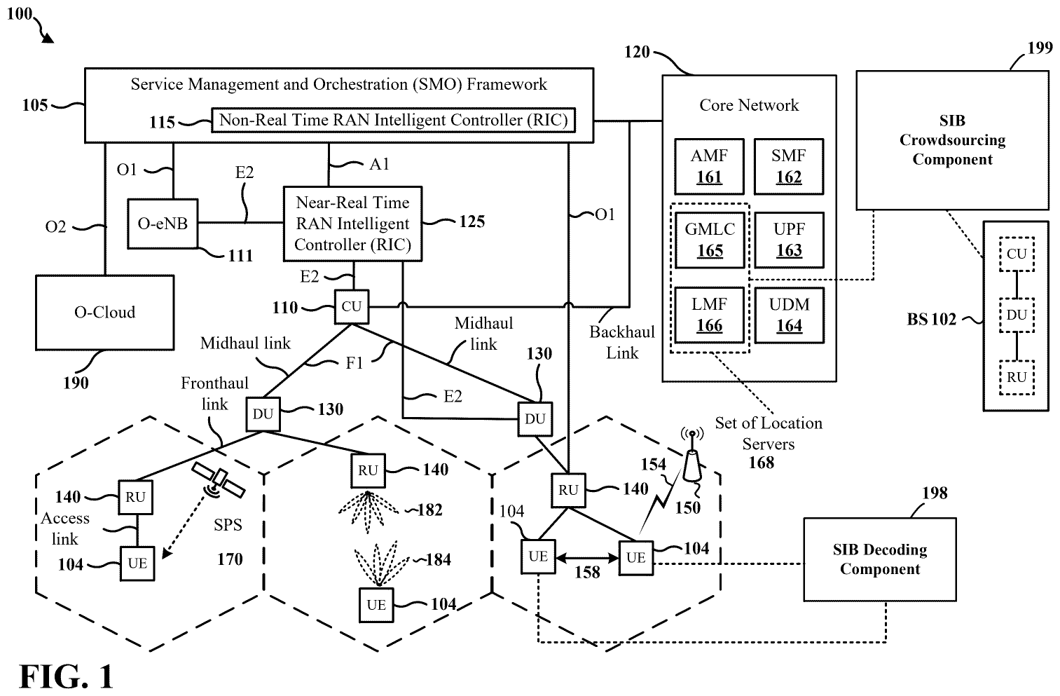

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an AI interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as AI policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a SIB decoding component 198 that may be configured to receive, from a network entity, a portion of information related to a system information block (SIB) based on a position of the UE, where the SIB is associated with a time transfer, where the information related to the SIB includes at least one of: an availability of the SIB, a type of the SIB, a transmitting interval of the SIB, a time uncertainty (TUNC) associated with the SIB, a time error associated with the SIB, or a reliability of a serving cell timing; and decode the SIB based on the portion of the information. In certain aspects, the base station 102 or the one or more location servers 168 may have a SIB crowdsourcing component 199 that may be configured to receive, from a first set of UEs, (1) information related to a SIB, (2) position information of the first set of UEs, and (3) time information of the first set of UEs, where the SIB is associated with a time transfer, where the information related to the SIB includes at least one of: an availability of the SIB, a type of the SIB, a transmitting interval of the SIB, a TUNC associated with the SIB, a time error associated with the SIB, or a reliability of a serving cell timing; and transmit, to a second UE based on the information related to the SIB, the position information, and the time information, a portion of the information related to the SIB based on a position of the second UE.

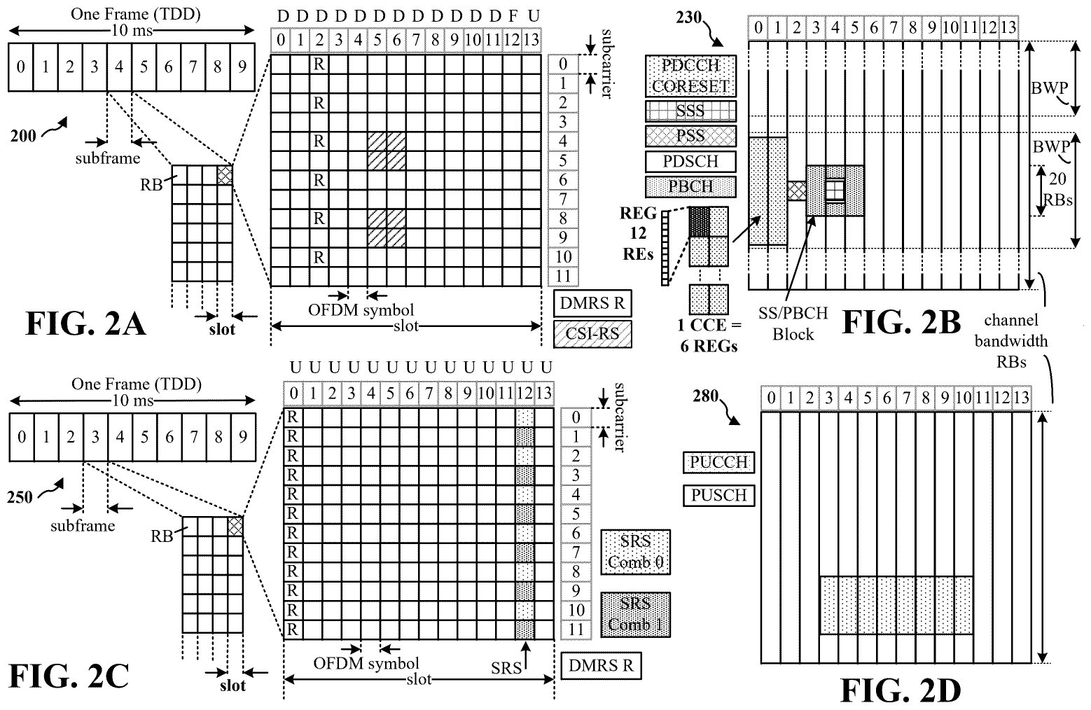

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2*15 kHz, where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology p=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

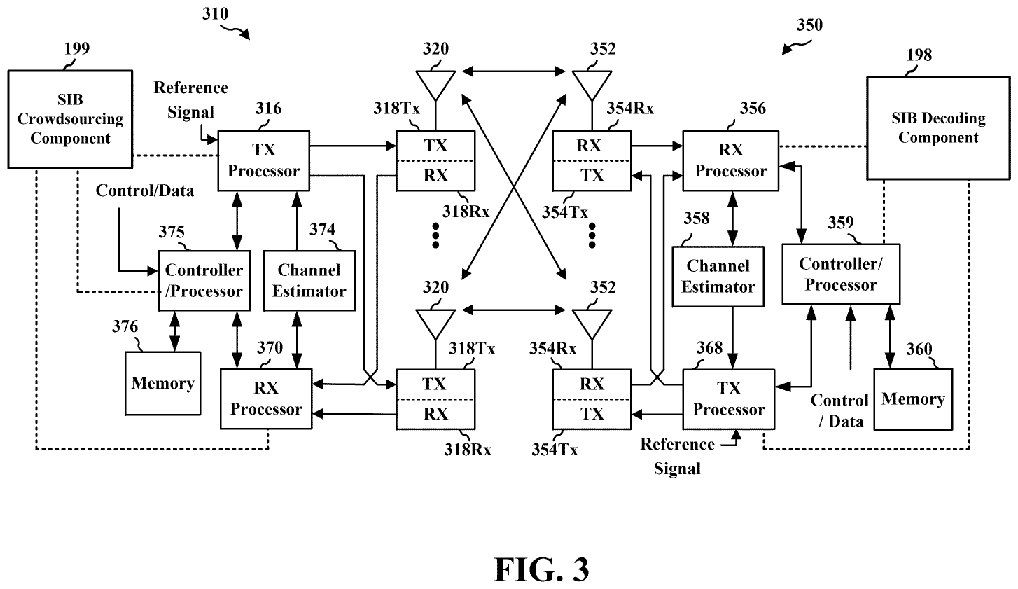

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the SIB decoding component 198 of FIG. 1.

At least one of the TX processor 316, the RX processor 370, and the controller/processor 375 may be configured to perform aspects in connection with the SIB crowdsourcing component 199 of FIG. 1.

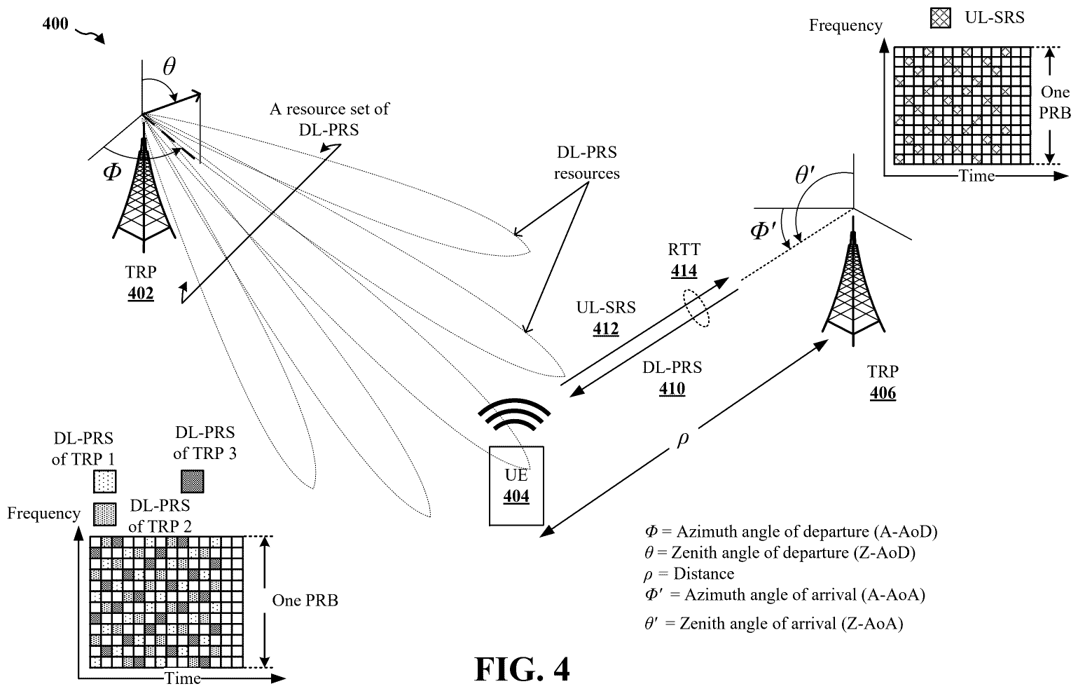

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

A device (e.g., a UE) equipped with a global navigation satellite system (GNSS) receiver may determine its location based on reception of signals from multiple satellites, which may be referred to as “GNSS-based positioning” or “satellite-based positioning.” GNSS is a network of satellites broadcasting timing and orbital information used for navigation and positioning measurements. In addition, GNSS may refer to the International Multi-Constellation Satellite System, which may include global positioning system (GPS), global navigation satellite system (GLONASS), Beidou, Galileo, and any other constellation system. GNSS may include multiple groups of satellites (which may be referred to as GNSS satellites), known as constellations, that broadcast signals (which may be referred to as GNSS signals) to control stations and users of the GNSS. Based on the broadcast signals, the users may be able to determine their locations (e.g., via a trilateration process). For purposes of the present disclosure, a device (e.g., a UE) that is equipped with a GNSS receiver or is capable of receiving GNSS signals may be referred to as a GNSS device, and a device that is capable of transmitting GNSS signals, such as a satellite, may be referred to as a space vehicle (SV).

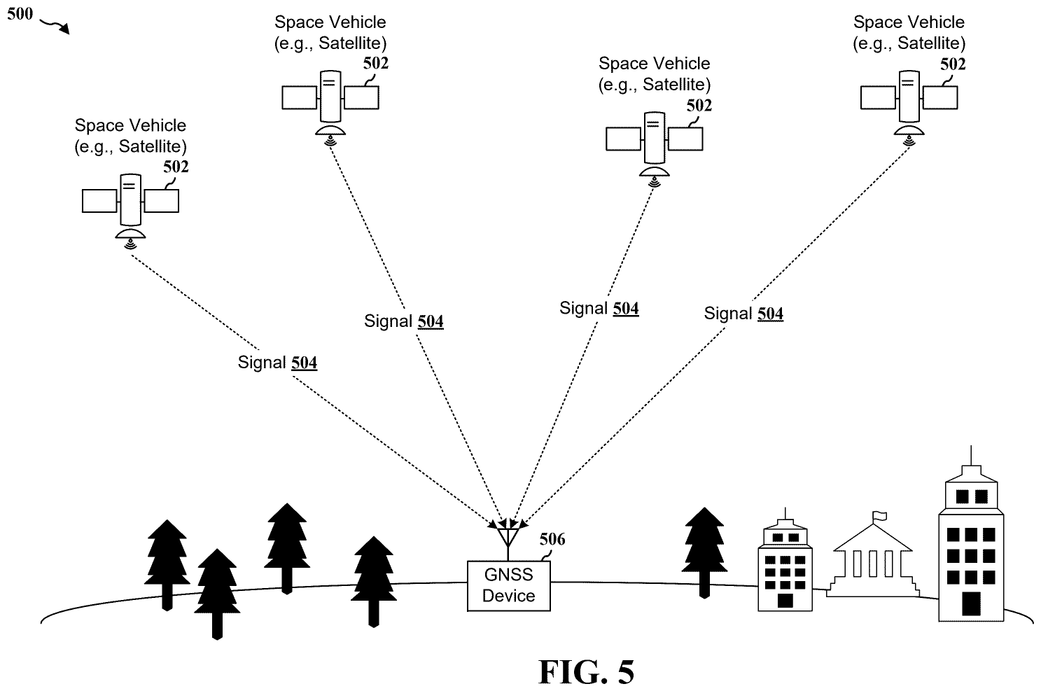

FIG. 5 is a diagram 500 illustrating an example of GNSS positioning in accordance with various aspects of the present disclosure. A GNSS device 506 may calculate its position and time based at least in part on data (e.g., GNSS signals 504) received from multiple space vehicles (SVs) 502, where each SV 502 may carry a record of its position and time and may transmit that data (e.g., the record) to the GNSS device 506. Each SV 502 may further include a clock that is synchronized with other clocks of SVs and with ground clock(s). If an SV 502 detects that there is a drift from the time maintained on the ground, the SV 502 may correct it. The GNSS device 506 may also include a clock, but the clock for the GNSS device 506 may be less stable and precise compared to the clocks for each SV 502.

As the speed of radio waves may be constant and independent of the satellite speed, a time delay between a time the SV 502 transmits a GNSS signal 504 and a time the GNSS device 506 receives the GNSS signal 504 may be proportional to the distance from the SV 502 to the GNSS device 506. In some examples, a minimum of four SVs may be used by the GNSS device 506 to compute/calculate one or more unknown quantities associated with positioning (e.g., three position coordinates and clock deviation from satellite time, etc.).

Each SV 502 may broadcast the GNSS signal 504 (e.g., a carrier wave with modulation) continuously that may include a pseudorandom code (e.g., a sequence of ones and zeros) which may be known to the GNSS device 506, and may also include a message that includes a time of transmission and the SV position at that time. In other words, each GNSS signal 504 may carry two types of information: time and carrier wave (e.g., a modulated waveform with an input signal to be electromagnetically transmitted). Based on the GNSS signals 504 received from each SV 502, the GNSS device 506 may measure the time of arrivals (TOAs) of the GNSS signals 504 and calculate the time of flights (TOFs) for the GNSS signals 504. Then, based on the TOFs, the GNSS device 506 may compute its three-dimensional position and clock deviation, and the GNSS device 506 may determine its position on the Earth. For example, the GNSS device 506's location may be converted to a latitude, a longitude, and a height relative to an ellipsoidal Earth model. These coordinates may be displayed, such as on a moving map display, or recorded or used by some other system, such as a vehicle guidance system.

While the distance between a GNSS device and an SV may be calculated based on the time it takes for a GNSS signal to reach the GNSS device, the SV's signal sequence may be delayed in relation to the GNSS device's sequence. Thus, in some examples, a delay may be applied to the GNSS device's sequence, such that the two sequences are aligned. For example, to calculate the delay, a GNSS device may align a pseudorandom binary sequence contained in the SV's signal to an internally generated pseudorandom binary sequence. As the SV's GNSS signal takes time to reach the GNSS device, the SV's sequence may be delayed in relation to the GNSS device's sequence. By increasingly delaying the GNSS device's sequence, the two sequences may eventually be aligned.

The accuracy of GNSS-based positioning may depend on various factors, such as satellite geometry, signal blockage, atmospheric conditions, and/or receiver design features/quality, etc. For example, GNSS receivers used by smartphones or smart watches may have lower accuracy compared to GNSS receivers used by vehicles and surveying equipments. To improve the accuracy of GNSS positioning (e.g., from meters to centimeters), a real time kinematics (RTK) technique or mechanism (which may collectively be referred to as an “RTK engine” hereafter) may be used for a positioning device (e.g., a UE, a surveying equipment, an automobile GNSS system, etc.). For example, an RTK engine may enable a positioning device to use correction information from a base station to mitigate one or more error sources in GNSS receiver pseudo-range (PR) and carrier-phase (CP) measurements, which may include satellite orbit error, satellite clock error, and/or atmospheric error, etc. Thus, better accuracy may be achieved by the positioning device.

Time-to-first-fix (TTFF) or time-to-fix (TTF) may refer to a duration of time specified for a GNSS device (or a GNSS receiver) to acquire signals from the satellites, perform trilateration, and obtain a position solution/estimation, sometimes referred to as a GNSS fix. This length of time may depend upon how the GNSS device is started up. For example, a cold start may take the longest amount of time for a GNSS receiver to obtain a GNSS fix as the GNSS receiver may not possess any information regarding where the satellites are located and/or the timing information related to the satellites.

In some implementation, to reduce the amount of time it takes for a GNSS device to obtain the GNSS fix (e.g., to reduce the TTFF), the GNSS device may have the capability (or may be configured to) obtain information related to GNSS satellites, such as their timing information, from a network. For example, a wireless wide area network (WWAN) may be configured to transmit various timing information related to the GNSS satellites (and/or other network entities), such as via a system information block (SIB). In some examples, this mechanism may be referred to as the “time transfer,” which means transferring the GNSS time from a WWAN to a UE (or the UE's GNSS receiver) via SIB(s), such that the UE may make use of the transferred time for GNSS position fix calculation (without having to decode the GNSS time over the air (OTA) from satellites). For example, a cellular network (or a base station) may perform WWAN time transfer using SIB type 8 (SIB8), SIB type 9 (SIB9) and/or SIB type 16 (SIB16), which may enable the cellular network to synchronize the time between the network and the connected devices (e.g., UEs, GNSS devices, etc.) and to provide various timing information to the connected devices.

Depending on implementations, SIB9 may be configured to provide information about the Coordinated Universal Time (UTC) and local time offset, which may include (1) Universal Terrestrial Radio Access Network (UTRAN) GPS time (e.g., derived from the GPS system, which is used by the UTRAN for synchronizing its operations), (2) UTC time information (e.g., the UTC time and/or the difference between the UTC time and the GPS time), and/or (3) daylight saving time (DST) information (e.g., may also include information on whether daylight saving is in effect and the offset due to DST), etc. SIB9 may be particularly useful for time-sensitive applications and for reducing the TTFF in GPS operations by providing accurate time information to the UEs. SIB16 may be similar to SIB9 but is used primarily for Long Term Evolution (LTE) networks. SIB16 may include (1) GPS timing information (e.g., the GPS time and the difference to UTC), (2) local time zone and DST Information, and/or (3) leap second information (e.g., information on leap seconds which may be important for high-precision timekeeping), etc.

Both SIB9 and SIB16 may play important roles in WWAN time transfer by enabling a network (e.g., a base station) to broadcast accurate time information to ensure synchronization of UEs with the network time. This synchronization is important for various applications, including positioning services, network operations, and other time-dependent services. For example, the WWAN time transfer mechanism may provide 3 dB in acquisition sensitivity, better position accuracy (e.g., compared to solve for time (SFT)-GNSS receiver may calculate its position directly by SFT if it has some coarse position(s) stored), approximately 50% improvement in TTFF for semi-weak signal condition, and/or power improvement, etc.

A network (or its base station(s)) may be configured to transmit SIB9/SIB16 via broadcasting (e.g., without subscription) and/or via dedicated RRC messaging (e.g., with subscription). Under the broadcasting configuration, the network may broadcast SIB9/SIB16 to all UEs (e.g., any capable devices) that are able to receive it. The advantage of broadcasting SIB9/SIB16 is that it may be free to UEs/users (e.g., no monthly fee or even no SIM card), consume lower power for UEs, and/or lower cost for users. However, a disadvantage is that there may be a large time uncertainty (TUNC) (e.g., approximately 100 μs) as a function of the distance between a UE and a base station. Under the dedicated RRC messaging configured, the network may transmit SIB9/SIB16 message(s) to UEs using dedicated signaling (e.g., RRC downlink information message(s)). The advantage is that the network may use timing advance (TA) may to make the time uncertainty independent of the distance (e.g., TUNC is approximately 1 μs). However, the disadvantage is that it specifies network service subscription and connection, which may consume higher power and associated with a higher cost (e.g., for the UEs/users).

While providing SIB9/SIB16 may leverage the existing infrastructure of the network to achieve synchronization, making it a cost-effective and versatile solution for various applications that demand precise timing synchronization, incorrect or inaccurate SIB9/SIB16 time aiding information from a wireless network may be catastrophic to GNSS. For example, an erroneous WWAN time transfer may cause a UE to end up with a longer TTFF, fail to track satellites, and/or encounter position outliers, etc. In some scenarios, this may also cause the UE to result in error recovery and sometimes even unable to recover (e.g., from a GNSS interruption/outage). In addition, if the UE does not have the capability to detect the incorrect or inaccurate SIB9/SIB16 time aiding information (which may be referred to as the “undetected time error”), this may cause errors such as false detection, miss detection, position error, de-sense, and/or wrong pulse per second (PPS), etc.

In some scenarios, TUNC associated with time transfer may vary based on the type of SIB transmission and/or cell coverage radius. For example, for a fixed TUNC (e.g., based on an upper bound) irrespective of the type of SIB9/SIB16, the corresponding cell coverage may be too extensive and may not meet application/use case demands. In some scenarios, SIB9/SIB16 may not be available. For example, SIB9/SIB16 may not be enabled by all carriers, or across all base stations served by the carrier. Thus, as described above, GNSS acquisition (e.g., the obtainment of a GNSS fix) at a GNSS device (e.g., a UE, a GNSS receiver, etc.) without SIB9/SIB16 aiding may likely impact positioning power and performance at the GNSS device. For example, for asset trackers/IoT devices that are configured to sporadically wake-up to report their locations, the power consumption of the GNSS acquisition may be very demanding for these devices.

Aspects presented herein may improve the overall positioning latency and performance at GNSS devices by enhancing the accuracy, the reliability, and the availability of SIB9/SIB16. Aspects presented herein provide techniques for crowdsourcing SIB9/SIB16 data and utilization of the crowdsourced SIB9/SIB16 data. For example, in one aspect of the present disclosure, a server may be configured to collect (e.g., crowdsource) SIB9/SIB16 related information from a first group of UEs (which may be referred to as “master UEs” for purposes of illustration and differentiation), where the SIB9/SIB16 related information may include SIB9/SIB16 availability, transmission type (e.g., broadcast, dedicated messaging), transmission interval, time uncertainty, time error, and/or reliability (of the current serving cell timing), etc. The first group of UEs may be configured to tag (e.g., include) SIB9/SIB16 related information they obtained with their current GNSS locations and/or GNSS time. Then, the server may provide the collected SIB9/SIB16 related information (which may be referred to as the “crowdsourced information” or the “crowdsourced SIB9/SIB16 information” to a second group of UEs (e.g., which may be referred to as “slave UEs” for purposes of illustration and differentiation), where the second group of UEs may decode SIB9/SIB16 or make SIB9/SIB16 decoding decisions based on the crowdsourced information. For example, the second group of UEs may make use of crowdsourced information from the server to check the availability of SIB9/SIB16 and make decision a priori whether to decode SIB9/SIB16 content or not. Aspects presented herein also enable GNSS devices to select cells for performing GNSS fix wakes up. As SIB9/SIB16 may provide signification power advantages and performance (e.g., faster time-to-fix (TTF)) in GNSS SV acquisition (e.g., avoids time decoding), which may be crucial for asset trackers/IoT devices, GNSS devices may be configured to schedule GNSS fix wake-ups just when they are in the vicinity of cell(s) with SIB9/SIB16 availability (e.g., obtained from the crowdsourced information) to save power. In some examples, GNSS devices may also be configured to obtain SIB9/SIB16 from alternate sources, such as decoding SIB9/SIB16 from neighboring cell(s), from other carriers, and/or from other WWAN technologies (e.g., 4G LTE, 5G NR, etc.).

For purposes of the present disclosure, crowdsourcing may refer to a mechanism for collecting information (which may be referred to as “crowdsourcing information” and/or “crowdsourcing data”) from a group of entities (e.g., UEs), usually via an online server (which may be referred to a “crowdsourcing server”). For example, crowdsourcing may involve obtaining data such as SIB9/SIB16 related information and/or location information from a group of UEs, where the group of UEs may submit the data to a crowdsourcing server or an Internet platform (e.g., social medias, mobile applications, etc.). Based on the data collected from the group of UEs, the crowdsourcing server may aggregate the data, analyze the data, and determine which set(s) of data may be useful or has good credibility to other devices. For example, a crowdsourcing server may collect weather conditions reported by a group of UEs within a region in real time. Based on the weather conditions received from the group of UEs, the crowdsourcing server may be able to determine the current weather condition at that region, and the crowdsourcing server may share the determined weather condition with other UEs (e.g., UEs that are in proximity to the region or moving towards the region).

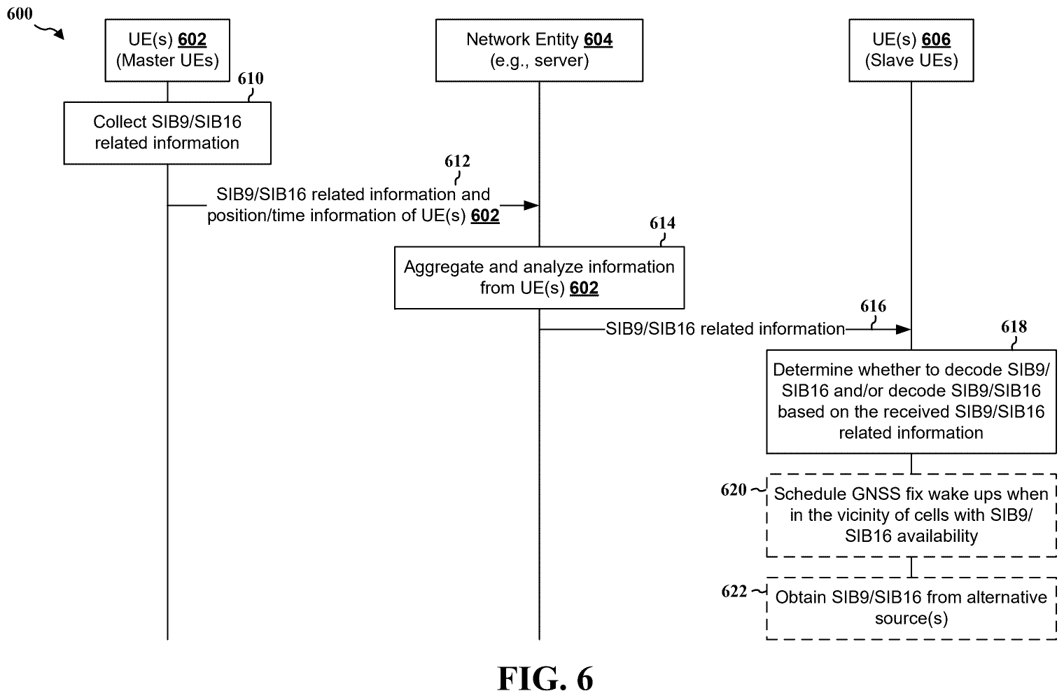

FIG. 6 is a communication flow 600 illustrating an example of a network entity crowdsourcing SIB9/SIB16 related information in accordance with various aspects of the present disclosure. The numberings associated with the communication flow 600 do not specify a particular temporal order and are merely used as references for the communication flow 600.

At 610, a first group of UEs 602, which may be referred to as “master UEs” for purposes of illustration and differentiation, may be configured to collect SIB9/SIB16 related information. For example, the first group of UEs 602 may receive and decode SIB9/SIB16 available to them, which may be broadcasted or transmitted (e.g., via dedicated RRC messages) to the first group of UEs 602 from one or more base stations.

At 612, the first group of UEs 602 may transmit, to a network entity 604 (e.g., a crowdsourcing server, an online server, etc.), the collected SIB9/SIB16 related information, the position information of the first group of UEs 602 (e.g., locations where the SIB9/SIB16 related information is collected), and the time information of the first group of UEs 602 (e.g., the time of when the SIB9/SIB16 related information is collected). Depending on implementations, the SIB9/SIB16 related information may include one or more of the followings: (1) the availability of SIB9/SIB16 (e.g., whether a location provides at least one of SIB9 or SIB16, or does not provide any SIB9/SIB16, etc.), (2) the SIB9/SIB16 transmission type (e.g., whether SIB9/SIB16 is broadcasted or transmitted via dedicated messaging), (3) the SIB9/SIB16 transmission interval (e.g., the frequency/periodicity in which the SIB9/SIB16 is transmitted from a base station/cell), (4) the time uncertainty (TUNC) associated with the SIB9/SIB16 (or with the base station/cell transmitting the SIB9/SIB16), (5) the time error associated with the SIB9/SIB16 (or with the base station/cell transmitting the SIB9/SIB16), and/or (6) the reliability (of the current serving cell timing). The first group of UEs 602 may tag the SIB9/SIB16 related information with their current GNSS locations and GNSS times.

In some examples, the first group of UEs 602 may compute/determine (1) the availability of SIB9/SIB16, (2) the SIB9/SIB16 transmission type, and/or (3) the SIB9/SIB16 transmission interval by decoding the over-the-air (OTA) SIB9/SIB16 data. In some examples, the first group of UEs 602 may compute/determine the (4) time uncertainty based on the SIB9/SIB16 transmission type (e.g., broadcast SIB or on demand dedicated SIB), and/or based on a coverage radius/propagation delay model (e.g., based on the distance between a UE receiving the SIB and a base station transmitting the SIB). In some examples, the first group of UEs 602 may compute/determine (5) the time error based on the actual difference between SIB9/SIB16 time and a GPS/GNSS time which is not covered by the time uncertainty. In some implementations, if the time error is very large (e.g., exceeding a time error threshold, or is in the order of seconds), a UE (or the first group of UEs 602) may mark the cell timing as “invalid.” In some examples, the first group of UEs 602 may derive (6) the reliability (of the current serving cell timing) from the time error variations and/or from a past history of the cell timing inconsistency.

Note while examples discuss above use SIB9 (e.g., for 5G NR) and SIB16 (e.g., for 4G LTE) for illustration, aspects presented herein may also apply to other type of SIB with similar information, functions, and/or purposes. For example, aspects presented herein may also apply to SIB8 of 4G LTE and/or any SIBs that include information related to satellites/GNSS as well.

At 614, based on SIB9/SIB16 related information and the position/time information of the first group of UEs 602 collected from the first group of UEs 602, the network entity 604 may aggregate and analyze the collected information (e.g., the crowdsourcing information/data). For example, the network entity 604 may compare SIB9/SIB16 related information provided by multiple UEs (in the first group of UEs 602) that are in proximity to each other, and verify/determine whether particular SIB9/SIB16 information is accurate or inaccurate, or provide weight to the particular SIB9/SIB16 information. For example, if a majority of UEs that are in proximity to each other indicates that SIB9/SIB16 is available at a GNSS location while a minority of these UEs indicates that SIB9/SIB16 is not available at this GNSS location, the network entity 604 may be configured to discard/ignore the SIB9/SIB16 related information provided by the minority of these UEs, or assign less weights to the SIB9/SIB16 related information provided by them.

At 616, based on the aggregated and analyzed SIB9/SIB16 related information, the network entity 604 may transmit SIB9/SIB16 related information (or at least a portion of the SIB9/SIB16 related information) to a second group of UEs 606, which may be referred to as “slave UEs” for purposes of illustration and differentiation. For example, based on the current location and/or time of a UE (in the second group of UEs 606), the network entity 604 may transmit SIB9/SIB16 information that is specific to that location and/or time to the UE (e.g., collected from UEs in proximity to that location and/or time), such as the availability of SIB9/SIB16, the SIB9/SIB16 transmission type, the SIB9/SIB16 transmission interval, the time uncertainty, the time error, and/or the reliability associated with that location and/or time. Note there may be overlaps between the first group of UEs 602 and the second group of UEs. For example, a UE may contribute SIB9/SIB16 related information of a first location and/or time to the network entity 604, and receive SIB9/SIB16 related information of a second location and/or time from the network entity 604, etc.

At 618, after receiving the SIB9/SIB16 related information from the network entity 604, the second group of UEs 606 may determine whether to decode SIB9/SIB16 and/or decode SIB9/SIB16 based on the received SIB9/SIB16 related information. In other words, the second group of UEs 606 may make use of the crowdsourced information (e.g., the crowdsourced SIB9/SIB16 related information) from the network entity 604 to check if SIB9/SIB16 is available (e.g., at the location of the second group of UEs 606) and make decision a priori whether to decode SIB9/SIB16 content or not. For example, a UE (in the second group of UEs 606) may decide whether to decode SIB9/SIB16 based on: (1) whether the time uncertainty associated with the SIB9/SIB16 meets the application/use case specification/demand, (2) whether the SIB9/SIB16 transmission interval is lower/frequent enough to meet its specification (e.g., such as power budget), (3) whether the time error associated with the SIB9/SIB16 (or the base station/cell transmitting the SIB9/SIB16) is within an acceptable range or not, (4) whether a cell timing is marked/labeled as “invalid” by the network entity 604 (e.g., if time error is greater than a threshold (Time Error>Threshold), it may indicate that the cell is not perfectly synchronized and the UE may skip SIB9 decode), and/or (5) whether the reliability of cell timing exceeds a threshold, etc.

By enabling UE(s) (e.g., the second group of UEs 606) to determine whether to decode SIB9/SIB16 and/or decode SIB9/SIB16 based on the received SIB9/SIB16 related information, UEs may achieve additional power/resource saving by avoiding unnecessary SIB9/SIB16 decoding and/or reducing SIB9/SIB16 decoding. In addition, detection of cell timing issues a priori may avoid catastrophic impacts to GNSS positioning for the UEs. In some scenarios, lower time uncertainty (TUNC) based on network entity 604 (e.g., server) inputs rather than fixed hardcoded time uncertainty may improve positioning performance at UEs, and may meet application demands (which may be useful for non GNSS timing applications as well).

In another aspect of the present disclosure, in some implementations, at 620, based on the SIB9/SIB16 related information, the second group of UEs 606 may be configured to schedule GNSS fix wake-ups when they are in the vicinity of cell(s) with SIB9/SIB16 availability. As discussed above, SIB9/SIB16 may provide signification power advantages and performance (e.g., faster TTF) to UEs during GNSS SV acquisition (e.g., avoids time decoding), which may be beneficial/crucial for UEs with low power budgets such as asset trackers and/or IoT devices. Thus, these UEs may be configured to schedule GNSS fix wake-ups just when they are in the vicinity of cell(s) with SIB9/SIB16 availability (e.g., obtained from the crowdsourced information at 616), and the UEs may remain in a power saving mode/sleep mode when they are not in the vicinity of cell(s) with SIB9/SIB16 to achieve additional power saving.

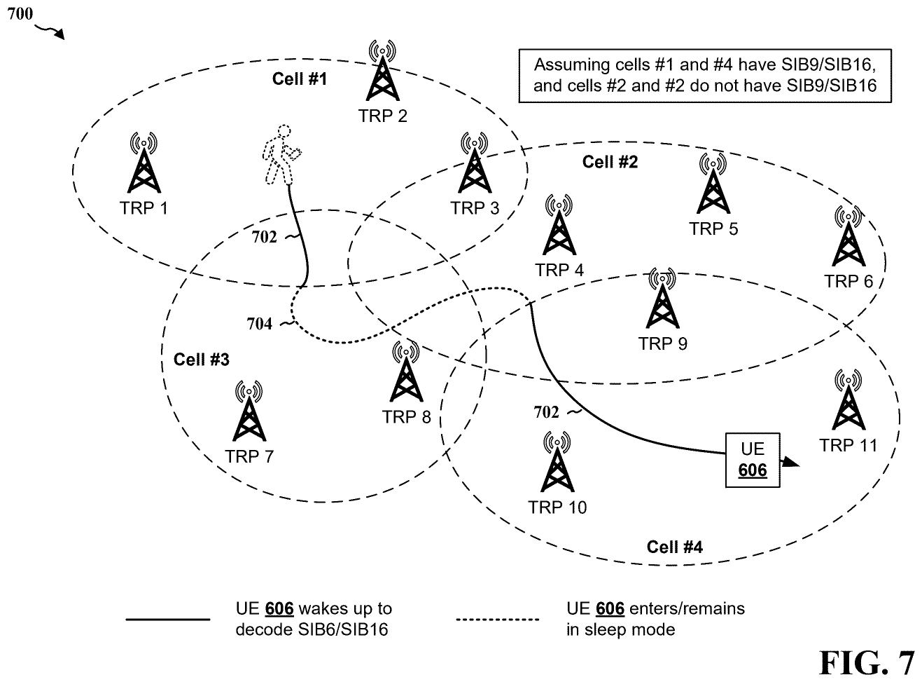

FIG. 7 is a diagram 700 illustrating an example of configuring a UE to wake-up (from a sleep/power saving mode) based on the availability of SIB9/SIB16 in accordance with various aspects of the present disclosure. In one example, as asset tracking using cloud services are gaining more traction nowadays, a cloud server (e.g., the network entity 604) may have the capability to specify route information (such as the starting point and/or the end destination, etc.) for an asset, and enable end users and/or the cloud server to periodically know where exactly the asset is located.

For example, using the crowdsourcing information discussed in connection with FIG. 6, the network entity 604 may be configured to provide, to the second group of UEs 606, pre-configured information with regards to cell(s) which have support for SIB9/SIB16 (and also more/additional information during the journey of the second group of UEs 606). By using this information, the second group of UEs 606 may align GNSS fix wake-ups just when they are at or approaching the cell(s) with SIB9/SIB16 to avoid power drain and to achieve better performance.

As an illustration, referring to the diagram 700, SIB9/SIB16 may be available at a first cell (Cell #1) and a fourth cell (Cell #4), but not available at a second cell (Cell #2) and a third cell (Cell #3). As shown at 702, based on knowing which cell(s) provide SIB9/SIB16 and which cell(s) do not provide SIB9/SIB16 (e.g., from the crowdsources information), a UE in the second group of UEs 606 (which may be referred to as the UE) may be configured to wake-up (for receiving and decoding SIB9/SIB16) when the UE in the second group of UEs 606 is within (or approaching) the first cell and the fourth cell. On the other hand, as shown at 704, when the UE in the second group of UEs 606 is at cell(s) that do not provide SIB9/SIB16, such as at the second cell and the third cell, the UE in the second group of UEs 606 may remain at or enter into a power saving/sleep mode to achieve additional power saving. In other words, the UE in the second group of UEs 606 (e.g., an IoT device, an asset tracker) may be configured to trigger GNSS fixes just in the vicinity of cells having SIB9/SIB16 support (Cells #1 and #4) during the journey for power efficient and navigation support (e.g., knowing the cell capability a priori may likely help the UE in the second group of UEs 606 to conserve its power). The network entity 604 may continue to provide/update the availability of SIB9/SIB16 of cells in proximity to the UE in the second group of UEs 606 as the UE moves, such as based on information provided by the first group of UEs 602.

In some examples, a soft GNSS feature may be implemented on constrained platforms (e.g., platforms with limited cost and/or size, etc.), where GNSS performance specification may be somewhat relaxed. For example, if a discrete GNSS (receiver) attaching to a platform/UE is undesirable/unsuitable due to cost, a software (SW) implementation of GNSS functionality on the platform/UE may be a viable/alternative method to enable GNSS features. Such platform/UE may be referred to as a soft GNSS device for purposes of the present disclosure. In some scenarios, WWAN RF/digital front-end (DFE) on soft GNSS devices may be reused for GNSS, where GNSS functionality is implemented in SW, and the SW implementation may also split the functionality between a client device (e.g., the UE in the second group of UEs 606) and a server (e.g., the network entity 604).

A soft GNSS device may demand approximate position, time (e.g., TUNC<2 seconds), and/or SV assistance for computing SV measurements, where the soft GNSS device may obtain the time assistance from a network time protocol (NTP) server. This may specify the soft GNSS device to have a data connection with the NTP server, and the time uncertainty may be large (e.g., in the order of seconds). However, with the time assistance from SIB9/SIB16 (TUNC in the order of μs), the soft GNSS device may quickly narrow down its GNSS search window. As such, in another aspect of the present disclosure, based on crowdsourced assistance about SIB9/SIB16, a soft GNSS device (or receiver) (e.g., a UE in the second group of UEs 606) may be configured to align GNSS fix wake-ups just when it is at the cell(s) with SIB9/SIB16 (e.g., to narrow down its GNSS search window). As such, the soft GNSS device may also save additional NTP time download overhead or OTA decode, which may help the soft GNSS device to avoid power drain (e.g., instead of NTP time or OTA decode) and improve the positioning (e.g., faster fix).

Referring back to FIG. 6, in some implementations, at 622, based on the SIB9/SIB16 related information received from the network entity 604 (e.g., at 616), the second group of UEs 606 may be able to obtain SIB9/SIB16 from one or more alternate sources. For example, the second group of UEs 606 may be configured to decode SIB9/SIB16 from neighboring cell(s). In some scenarios, SIB9/SIB16 may not be available on the current serving cell of a UE (e.g., may be one of the second group of UEs 606), but may be available on the neighboring cell(s) of the UE. Thus, the UE may obtain this information from the crowdsourced server (e.g., the network entity 604), and the UE may attempt to decode SIB9/SIB16 on the neighboring cell(S). In some examples, the UE may also be configured to make use of secondary receiver chains (e.g., used for carrier aggregation) to decode the SIB9/SIB16 from neighboring cell(s).

In another example, the second group of UEs 606 may be configured to decode SIB9/SIB16 from other carrier(s). For example, on a dual subscriber identity module (SIM) UE (e.g., may be one of the second group of UEs 606) with two subscriptions (SUBs), SIB9/SIB16 may be enabled in just one of the two carrier SUBs (e.g., assuming not available on the primary carrier SUB but available on the secondary carrier SUB). Based on the crowdsourced information from the crowdsourcing server (e.g., the network entity 604), the dual SIM UE may choose which SUB to use based on the availability of the SIB9/SIB16 (e.g., the secondary carrier SUB) and decode the SIB9/SIB16 (at least for the time transfer purpose). In addition, if the dual SIM UE supports the dual-SIM dual-active (DSDA) feature, the dual SIM UE may also enable the DSDA feature for decoding the SIB9/SIB16 data if its primary carrier SUB is in the connected state.

In another example, the second group of UEs 606 may be configured to decode SIB9/SIB16 from other WWAN technologies. For example, a UE (e.g., may be one of the second group of UEs 606) may be camped to a 5G network and SIB9 is not available at this 5G network, but SIB16 and/or SIB8 are available at a 4G network. Based on the crowdsourced information, the UE may be configured to fall back to the 4G network and attempt to decode the SIB16 and/or SIB8 on the 4G network (at least for the time transfer purpose). In some examples, if the UE supports the non-standalone (NSA) mode, based on the crowdsourced information, the UE may decode SIB16/SIB8 from the 4G network without fallback.

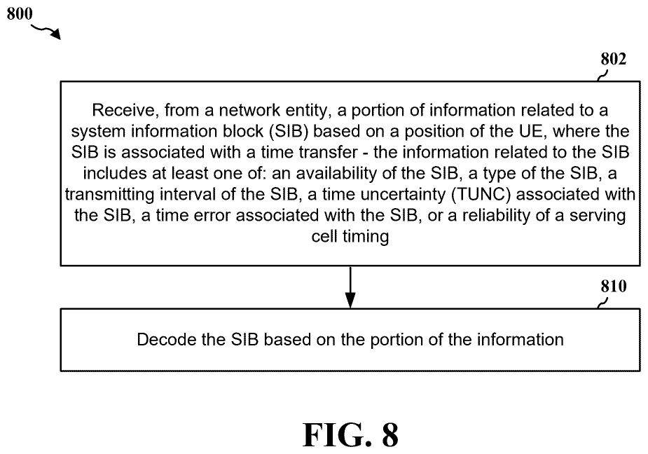

FIG. 8 is a flowchart 800 of a method of wireless communication at a user equipment (UE). The method may be performed by a UE (e.g., the UE 104, 404; the GNSS device 506; a UE in the first group of UEs 602; a UE in the second group of UEs 606; the apparatus 1004). The method may enable the UE to obtain and utilize crowdsourced SIB9/SIB16 data from a server do determine whether to decode SIB9/SIB16 to improve the overall performance of positioning and power consumption.

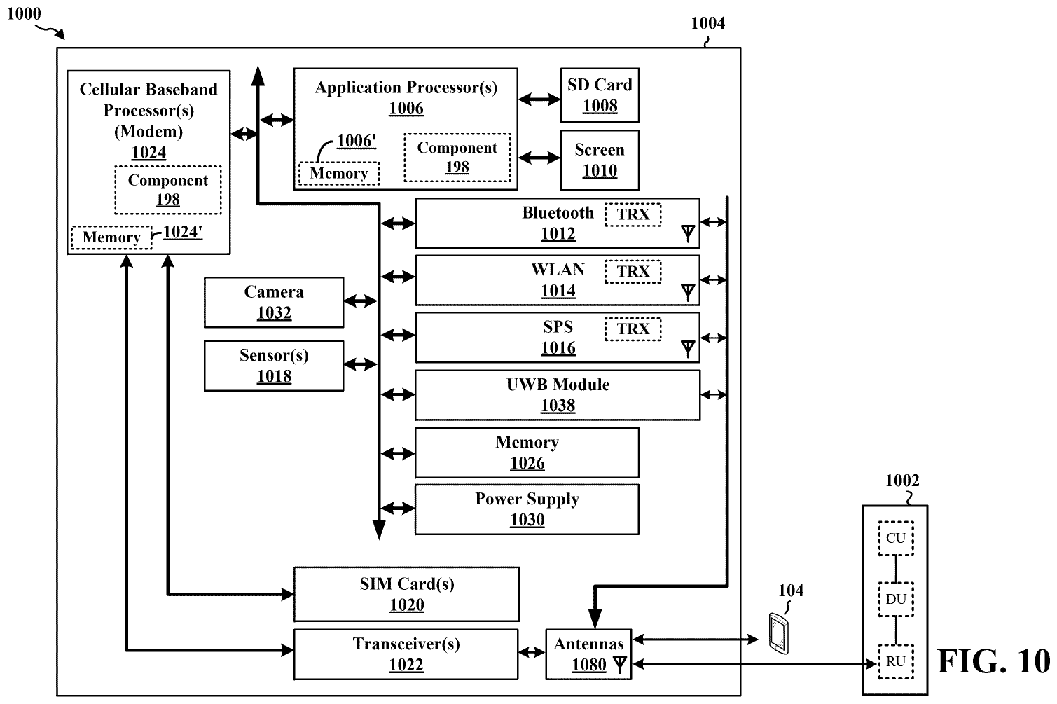

At 802, a UE may receive, from a network entity, a portion of information related to a system information block (SIB) based on a position of the UE, where the SIB is associated with a time transfer, where the information related to the SIB includes at least one of: an availability of the SIB, a type of the SIB, a transmitting interval of the SIB, a time uncertainty (TUNC) associated with the SIB, a time error associated with the SIB, or a reliability of a serving cell timing, such as described in connection with FIG. 6. For example, at 616, the second group of UEs 606 may receive SIB9/SIB16 related information (or at least a portion of the SIB9/SIB16 related information) from the network entity 604. For example, based on the current location and/or time of a UE (in the second group of UEs 606), the network entity 604 may transmit SIB9/SIB16 information that is specific to that location and/or time to the UE (e.g., collected from UEs in proximity to that location and/or time), such as the availability of SIB9/SIB16, the SIB9/SIB16 transmission type, the SIB9/SIB16 transmission interval, the time uncertainty, the time error, and/or the reliability associated with that location and/or time. The reception of the portion of information related to the SIB may be performed by, e.g., the SIB decoding component 198, the transceiver(s) 1022, the cellular baseband processor(s) 1024, and/or the application processor(s) 1006 of the apparatus 1004 in FIG. 10.

In one example, the SIB includes at least one of: a SIB type 8 (SIB8), a SIB type 9 (SIB9), or a SIB type 16 (SIB16).

In another example, the type of the SIB includes at least one of a broadcast message or a dedicated message.

In another example, the network entity is a crowdsourcing server, a location server, or a location management function (LMF).

At 810, the UE may decode the SIB based on the portion of the information, such as described in connection with FIG. 6. For example, at 618, after receiving the SIB9/SIB16 related information from the network entity 604, the second group of UEs 606 may determine whether to decode SIB9/SIB16 and/or decode SIB9/SIB16 based on the received SIB9/SIB16 related information. The decoding of the SIB may be performed by, e.g., the SIB decoding component 198, the transceiver(s) 1022, the cellular baseband processor(s) 1024, and/or the application processor(s) 1006 of the apparatus 1004 in FIG. 10.

In one example, to decode the SIB based the portion of the information, the UE may be configured to determine whether to decode the SIB based on at least one of: whether the SIB associated with the time transfer is available, whether the TUNC meets a TUNC threshold or a specification, whether the transmitting interval of the SIB meets an interval threshold, whether the time error is within a defined range, or whether the reliability of the serving cell timing is valid, and decode the SIB based on the determination.

In another example, if the information related to the SIB includes the availability of the SIB for a current cell and one or more neighboring cells, the UE may be configured to decode the SIB from a neighboring cell based on the SIB being available on the neighboring cell and unavailable on the current cell, such as described in connection with FIG. 6. For example, at 622, based on the SIB9/SIB16 related information received from the network entity 604 (e.g., at 616), the second group of UEs 606 may be configured to decode SIB9/SIB16 from neighboring cell(s). The decoding of the SIB from a neighboring cell may be performed by, e.g., the SIB decoding component 198, the transceiver(s) 1022, the cellular baseband processor(s) 1024, and/or the application processor(s) 1006 of the apparatus 1004 in FIG. 10. In some implementations, to decode the SIB from the neighboring cell, the UE may be configured to decode the SIB from the neighboring cell using of a secondary receiver chain.

In another example, if the information related to the SIB includes the availability of the SIB for a set of carriers, the UE may be configured to select a carrier in the set of carriers for decoding the SIB for the time transfer based on the SIB being available at the carrier, such as described in connection with FIG. 6. For example, at 622, based on the SIB9/SIB16 related information received from the network entity 604 (e.g., at 616), the second group of UEs 606 may be configured to decode SIB9/SIB16 from other carrier(s). The selection of the carrier may be performed by, e.g., the SIB decoding component 198, the transceiver(s) 1022, the cellular baseband processor(s) 1024, and/or the application processor(s) 1006 of the apparatus 1004 in FIG. 10. In some implementations, the UE may be a dual subscriber identity module (SIM) device with at least two subscriptions to at least two carriers, and the UE may be configured to enable a dual SIM dual standby (DSDS) function for decoding the SIB.

In another example, if the information related to the SIB includes the availability of the SIB on a plurality of networks, the UE may be configured to select or switch to a network in the plurality of networks that supports the SIB for decoding the SIB, where the plurality of networks includes fifth generation (5G) new radio (NR) (5G NR) and fourth generation (4G) long term evolution (LTE) (4G LTE), such as described in connection with FIG. 6. For example, at 622, based on the SIB9/SIB16 related information received from the network entity 604 (e.g., at 616), the second group of UEs 606 may be configured to decode SIB9/SIB16 from other WWAN technologies. The selection or switching of the network may be performed by, e.g., the SIB decoding component 198, the transceiver(s) 1022, the cellular baseband processor(s) 1024, and/or the application processor(s) 1006 of the apparatus 1004 in FIG. 10.

In another example, if the information related to the SIB includes the availability of the SIB for a plurality of cells, the UE may be configured to schedule a set of wake-up times for decoding SIBs for one or more cells in the plurality of cells based on the availability of the SIB for the plurality of cells, such as described in connection with FIG. 6. For example, at 620, based on the SIB9/SIB16 related information, the second group of UEs 606 may be configured to schedule GNSS fix wake-ups when they are in the vicinity of cell(s) with SIB9/SIB16 availability. The scheduling of the set of wake-up times may be performed by, e.g., the SIB decoding component 198, the transceiver(s) 1022, the cellular baseband processor(s) 1024, and/or the application processor(s) 1006 of the apparatus 1004 in FIG. 10.

In another example, if the information related to the SIB includes the TUNC associated with the SIB, the UE may be configured to adjust a GNSS search window based on the TUNC associated with the SIB, such as described in connection with FIG. 6. For example, based on crowdsourced assistance about SIB9/SIB16, a soft GNSS device (or receiver) (e.g., a UE in the second group of UEs 606) may be configured to align GNSS fix wake-ups just when it is at the cell(s) with SIB9/SIB16 (e.g., to narrow down its GNSS search window). The adjustment of the GNSS search window may be performed by, e.g., the SIB decoding component 198, the transceiver(s) 1022, the cellular baseband processor(s) 1024, and/or the application processor(s) 1006 of the apparatus 1004 in FIG. 10.

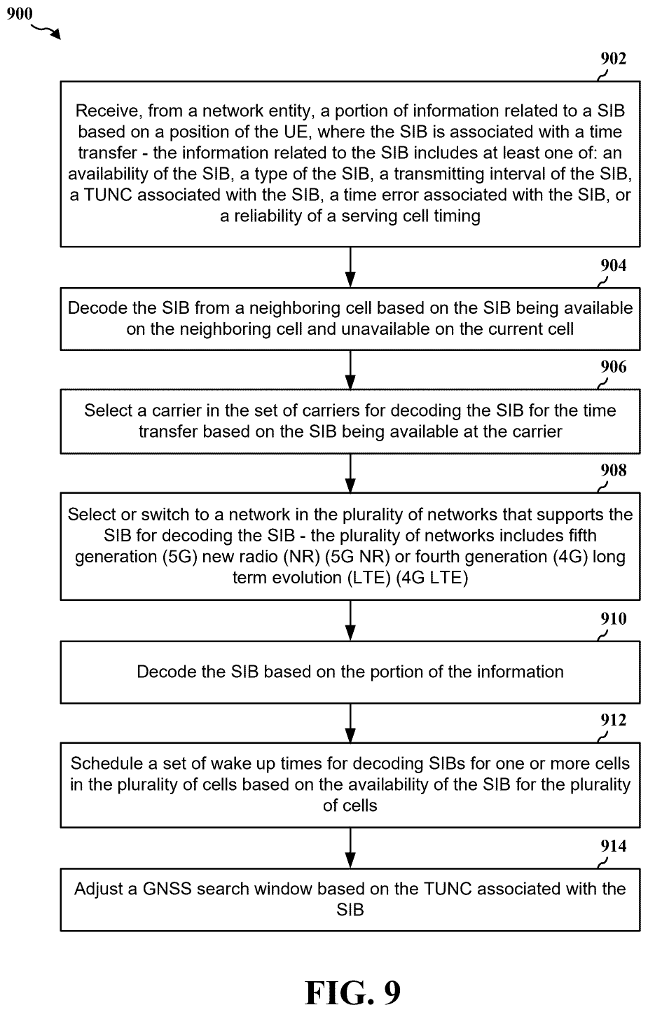

FIG. 9 is a flowchart 900 of a method of wireless communication at a user equipment (UE). The method may be performed by a UE (e.g., the UE 104, 404; the GNSS device 506; a UE in the first group of UEs 602; a UE in the second group of UEs 606; the apparatus 1004). The method may enable the UE to obtain and utilize crowdsourced SIB9/SIB16 data from a server do determine whether to decode SIB9/SIB16 to improve the overall performance of positioning and power consumption.

At 902, a UE may receive, from a network entity, a portion of information related to a SIB based on a position of the UE, where the SIB is associated with a time transfer, where the information related to the SIB includes at least one of: an availability of the SIB, a type of the SIB, a transmitting interval of the SIB, a TUNC associated with the SIB, a time error associated with the SIB, or a reliability of a serving cell timing, such as described in connection with FIG. 6. For example, at 616, the second group of UEs 606 may receive SIB9/SIB16 related information (or at least a portion of the SIB9/SIB16 related information) from the network entity 604. For example, based on the current location and/or time of a UE (in the second group of UEs 606), the network entity 604 may transmit SIB9/SIB16 information that is specific to that location and/or time to the UE (e.g., collected from UEs in proximity to that location and/or time), such as the availability of SIB9/SIB16, the SIB9/SIB16 transmission type, the SIB9/SIB16 transmission interval, the time uncertainty, the time error, and/or the reliability associated with that location and/or time. The reception of the portion of information related to the SIB may be performed by, e.g., the SIB decoding component 198, the transceiver(s) 1022, the cellular baseband processor(s) 1024, and/or the application processor(s) 1006 of the apparatus 1004 in FIG. 10.

In one example, the SIB includes at least one of: a SIB8, a SIB9, or a SIB16.

In another example, the type of the SIB includes at least one of a broadcast message or a dedicated message.

In another example, the network entity is a crowdsourcing server, a location server, or an LMF.

At 910, the UE may decode the SIB based on the portion of the information, such as described in connection with FIG. 6. For example, at 618, after receiving the SIB9/SIB16 related information from the network entity 604, the second group of UEs 606 may determine whether to decode SIB9/SIB16 and/or decode SIB9/SIB16 based on the received SIB9/SIB16 related information. The decoding of the SIB may be performed by, e.g., the SIB decoding component 198, the transceiver(s) 1022, the cellular baseband processor(s) 1024, and/or the application processor(s) 1006 of the apparatus 1004 in FIG. 10.

In one example, to decode the SIB based the portion of the information, the UE may be configured to determine whether to decode the SIB based on at least one of: whether the SIB associated with the time transfer is available, whether the TUNC meets a TUNC threshold or a specification, whether the transmitting interval of the SIB meets an interval threshold, whether the time error is within a defined range, or whether the reliability of the serving cell timing is valid, and decode the SIB based on the determination.

In another example, as shown at 904, if the information related to the SIB includes the availability of the SIB for a current cell and one or more neighboring cells, the UE may be configured to decode the SIB from a neighboring cell based on the SIB being available on the neighboring cell and unavailable on the current cell, such as described in connection with FIG. 6. For example, at 622, based on the SIB9/SIB16 related information received from the network entity 604 (e.g., at 616), the second group of UEs 606 may be configured to decode SIB9/SIB16 from neighboring cell(s). The decoding of the SIB from a neighboring cell may be performed by, e.g., the SIB decoding component 198, the transceiver(s) 1022, the cellular baseband processor(s) 1024, and/or the application processor(s) 1006 of the apparatus 1004 in FIG. 10. In some implementations, to decode the SIB from the neighboring cell, the UE may be configured to decode the SIB from the neighboring cell using of a secondary receiver chain.

In another example, as shown at 906, if the information related to the SIB includes the availability of the SIB for a set of carriers, the UE may be configured to select a carrier in the set of carriers for decoding the SIB for the time transfer based on the SIB being available at the carrier, such as described in connection with FIG. 6. For example, at 622, based on the SIB9/SIB16 related information received from the network entity 604 (e.g., at 616), the second group of UEs 606 may be configured to decode SIB9/SIB16 from other carrier(s). The selection of the carrier may be performed by, e.g., the SIB decoding component 198, the transceiver(s) 1022, the cellular baseband processor(s) 1024, and/or the application processor(s) 1006 of the apparatus 1004 in FIG. 10. In some implementations, the UE may be a dual SIM device with at least two subscriptions to at least two carriers, and the UE may be configured to enable a DSDS function for decoding the SIB.

In another example, as shown at 908, if the information related to the SIB includes the availability of the SIB on a plurality of networks, the UE may be configured to select or switch to a network in the plurality of networks that supports the SIB for decoding the SIB, where the plurality of networks includes 5G NR and 4G LTE, such as described in connection with FIG. 6. For example, at 622, based on the SIB9/SIB16 related information received from the network entity 604 (e.g., at 616), the second group of UEs 606 may be configured to decode SIB9/SIB16 from other WWAN technologies. The selection or switching of the network may be performed by, e.g., the SIB decoding component 198, the transceiver(s) 1022, the cellular baseband processor(s) 1024, and/or the application processor(s) 1006 of the apparatus 1004 in FIG. 10.

In another example, as shown at 912, if the information related to the SIB includes the availability of the SIB for a plurality of cells, the UE may be configured to schedule a set of wake-up times for decoding SIBs for one or more cells in the plurality of cells based on the availability of the SIB for the plurality of cells, such as described in connection with FIG. 6. For example, at 620, based on the SIB9/SIB16 related information, the second group of UEs 606 may be configured to schedule GNSS fix wake-ups when they are in the vicinity of cell(s) with SIB9/SIB16 availability. The scheduling of the set of wake-up times may be performed by, e.g., the SIB decoding component 198, the transceiver(s) 1022, the cellular baseband processor(s) 1024, and/or the application processor(s) 1006 of the apparatus 1004 in FIG. 10.

In another example, as shown at 914, if the information related to the SIB includes the TUNC associated with the SIB, the UE may be configured to adjust a GNSS search window based on the TUNC associated with the SIB, such as described in connection with FIG. 6. For example, based on crowdsourced assistance about SIB9/SIB16, a soft GNSS device (or receiver) (e.g., a UE in the second group of UEs 606) may be configured to align GNSS fix wake-ups just when it is at the cell(s) with SIB9/SIB16 (e.g., to narrow down its GNSS search window). The adjustment of the GNSS search window may be performed by, e.g., the SIB decoding component 198, the transceiver(s) 1022, the cellular baseband processor(s) 1024, and/or the application processor(s) 1006 of the apparatus 1004 in FIG. 10.

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include at least one cellular baseband processor 1024 (also referred to as a modem) coupled to one or more transceivers 1022 (e.g., cellular RF transceiver). The cellular baseband processor(s) 1024 may include at least one on-chip memory 1024′. In some aspects, the apparatus 1004 may further include one or more subscriber identity modules (SIM) cards 1020 and at least one application processor 1006 coupled to a secure digital (SD) card 1008 and a screen 1010. The application processor(s) 1006 may include on-chip memory 1006′. In some aspects, the apparatus 1004 may further include a Bluetooth module 1012, a WLAN module 1014, an ultrawide band (UWB) module 1038, an SPS module 1016 (e.g., GNSS module), one or more sensors 1018 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the UWB module 1038, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor(s) 1024 communicates through the transceiver(s) 1022 via one or more antennas 1080 with the UE 104 and/or with an RU associated with a network entity 1002. The cellular baseband processor(s) 1024 and the application processor(s) 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor(s) 1024 and the application processor(s) 1006 are each responsible for general processing, including the execution of software stored on the computer-readable medium/memory. The software, when executed by the cellular baseband processor(s) 1024/application processor(s) 1006, causes the cellular baseband processor(s) 1024/application processor(s) 1006 to perform the various functions described supra. The cellular baseband processor(s) 1024 and the application processor(s) 1006 are configured to perform the various functions described supra based at least in part of the information stored in the memory. That is, the cellular baseband processor(s) 1024 and the application processor(s) 1006 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1024/application processor(s) 1006 when executing software. The cellular baseband processor(s) 1024/application processor(s) 1006 may be a component of the UE 350 and may include the at least one memory 360 and/or at least one of the TX processor 368, the RX processor 356, and the controller/processor 359. In one configuration, the apparatus 1004 may be at least one processor chip (modem and/or application) and include just the cellular baseband processor(s) 1024 and/or the application processor(s) 1006, and in another configuration, the apparatus 1004 may be the entire UE (e.g., see UE 350 of FIG. 3) and include the additional modules of the apparatus 1004.

As discussed supra, the SIB decoding component 198 may be configured to receive, from a network entity, a portion of information related to a SIB based on a position of the UE, where the SIB is associated with a time transfer, where the information related to the SIB includes at least one of: an availability of the SIB, a type of the SIB, a transmitting interval of the SIB, a TUNC associated with the SIB, a time error associated with the SIB, or a reliability of a serving cell timing. The SIB decoding component 198 may also be configured to decode the SIB based on the portion of the information. The SIB decoding component 198 may be within the cellular baseband processor(s) 1024, the application processor(s) 1006, or both the cellular baseband processor(s) 1024 and the application processor(s) 1006. The SIB decoding component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1004 may include a variety of components configured for various functions. In one configuration, the apparatus 1004, and in particular the cellular baseband processor(s) 1024 and/or the application processor(s) 1006, may include means for receiving, from a network entity, a portion of information related to a SIB based on a position of the UE, where the SIB is associated with a time transfer, where the information related to the SIB includes at least one of: an availability of the SIB, a type of the SIB, a transmitting interval of the SIB, a TUNC associated with the SIB, a time error associated with the SIB, or a reliability of a serving cell timing. The apparatus 1004 may further include means for decoding the SIB based on the portion of the information.

In one configuration, the SIB includes at least one of: a SIB8, a SIB9, or a SIB16.

In another configuration, the type of the SIB includes at least one of a broadcast message or a dedicated message.

In another configuration, the network entity is a crowdsourcing server, a location server, or an LMF.

In another configuration, the means for decoding the SIB based the portion of the information may include configuring the apparatus 1004 to determine whether to decode the SIB based on at least one of: whether the SIB associated with the time transfer is available, whether the TUNC meets a TUNC threshold or a specification, whether the transmitting interval of the SIB meets an interval threshold, whether the time error is within a defined range, or whether the reliability of the serving cell timing is valid, and decode the SIB based on the determination.

In another configuration, if the information related to the SIB includes the availability of the SIB for a current cell and one or more neighboring cells, the apparatus 1004 may further include means for decoding the SIB from a neighboring cell based on the SIB being available on the neighboring cell and unavailable on the current cell. In some implementations, the means for decoding the SIB from the neighboring cell may include configuring the apparatus 1004 to decode the SIB from the neighboring cell using of a secondary receiver chain.

In another configuration, if the information related to the SIB includes the availability of the SIB for a set of carriers, the apparatus 1004 may further include means for selecting a carrier in the set of carriers for decoding the SIB for the time transfer based on the SIB being available at the carrier. In some implementations, the apparatus 1004 may be a dual SIM device with at least two subscriptions to at least two carriers, and the apparatus 1004 may be configured to enable a DSDS function for decoding the SIB.

In another configuration, if the information related to the SIB includes the availability of the SIB on a plurality of networks, the apparatus 1004 may further include means for selecting or means for switching to a network in the plurality of networks that supports the SIB for decoding the SIB, where the plurality of networks includes 5G NR and 4G LTE.

In another configuration, if the information related to the SIB includes the availability of the SIB for a plurality of cells, the apparatus 1004 may further include means for scheduling a set of wake-up times for decoding SIBs for one or more cells in the plurality of cells based on the availability of the SIB for the plurality of cells.

In another configuration, if the information related to the SIB includes the TUNC associated with the SIB, the apparatus 1004 may further include means for adjusting a GNSS search window based on the TUNC associated with the SIB.

The means may be the SIB decoding component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

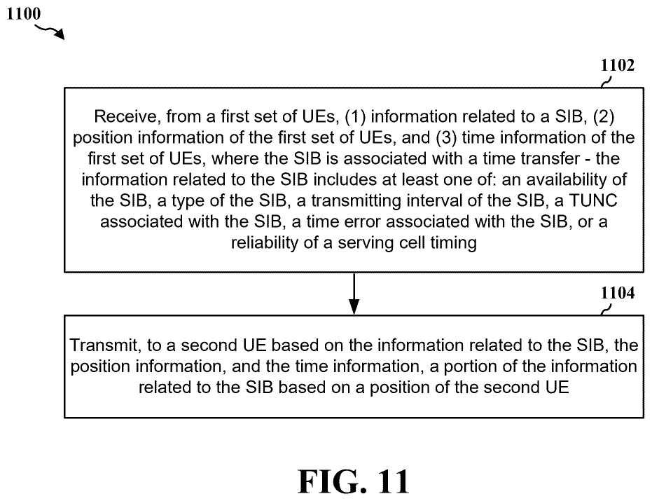

FIG. 11 is a flowchart 1100 of a method of wireless communication. The method may be performed by a network entity (e.g., the one or more location servers 168; network entity 604, 1260). The method may enable the network entity to obtain crowdsourced SIB9/SIB16 data from a group of UEs, and distribute the crowdsourced SIB9/SIB16 data to other group of UEs to improve their overall positioning performance and power consumption.

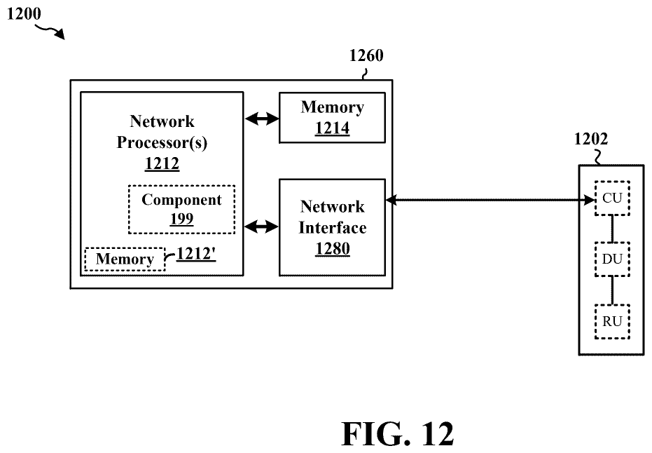

At 1102, the network entity may receive, from a first set of UEs, (1) information related to a SIB, (2) position information of the first set of UEs, and (3) time information of the first set of UEs, where the SIB is associated with a time transfer, where the information related to the SIB includes at least one of: an availability of the SIB, a type of the SIB, a transmitting interval of the SIB, a TUNC associated with the SIB, a time error associated with the SIB, or a reliability of a serving cell timing, such as described in connection with FIG. 6. For example, at 612, the network entity 604 may receive, from the first group of UEs 602, the SIB9/SIB16 related information collected by the first group of UEs 602, the position information of the first group of UEs 602 (e.g., locations where the SIB9/SIB16 related information is collected), and the time information of the first group of UEs 602 (e.g., the time of when the SIB9/SIB16 related information is collected). Depending on implementations, the SIB9/SIB16 related information may include one or more of the followings: (1) the availability of SIB9/SIB16 (e.g., whether a location provides at least one of SIB9 or SIB16, or does not provide any SIB9/SIB16, etc.), (2) the SIB9/SIB16 transmission type (e.g., whether SIB9/SIB16 is broadcasted or transmitted via dedicated messaging), (3) the SIB9/SIB16 transmission interval (e.g., the frequency/periodicity in which the SIB9/SIB16 is transmitted from a base station/cell), (4) the TUNC associated with the SIB9/SIB16 (or with the base station/cell transmitting the SIB9/SIB16), (5) the time error associated with the SIB9/SIB16 (or with the base station/cell transmitting the SIB9/SIB16), and/or (6) the reliability (of the current serving cell timing). The reception of the information related to a SIB, the position information of the first set of UEs, and the time information of the first set of UEs may be performed by, e.g., the SIB crowdsourcing component 199, the network processor(s) 1212, and/or the network interface 1280 of the network entity 1260 in FIG. 12.

At 1104, the network entity may transmit, to a second UE based on the information related to the SIB, the position information, and the time information, a portion of the information related to the SIB based on a position of the second UE, such as described in connection with FIG. 6. For example, at 616, the network entity 604 may transmit, to the second group of UEs 606, SIB9/SIB16 related information (or at least a portion of the SIB9/SIB16 related information). For example, based on the current location and/or time of a UE (in the second group of UEs 606), the network entity 604 may transmit SIB9/SIB16 information that is specific to that location and/or time to the UE (e.g., collected from UEs in proximity to that location and/or time), such as the availability of SIB9/SIB16, the SIB9/SIB16 transmission type, the SIB9/SIB16 transmission interval, the time uncertainty, the time error, and/or the reliability associated with that location and/or time. The transmission of the portion of the information related to the SIB may be performed by, e.g., the SIB crowdsourcing component 199, the network processor(s) 1212, and/or the network interface 1280 of the network entity 1260 in FIG. 12.

In one example, the SIB includes at least one of: a SIB8, a SIB9, or a SIB16.

In another example, the position information includes a GNSS position of the first set of UEs at which the information related to the SIB is collected by the first set of UEs, and where the time information includes a GNSS time of the first set of UEs at which the information related to the SIB is collected by the first set of UEs.

In another example, the type of the SIB includes at least one of a broadcast message or a dedicated message.

In another example, the TUNC associated with the SIB corresponds to a coverage radius or a propagation delay between each UE in the first set of UEs and a corresponding base station.

In another example, the network entity is a crowdsourcing server, a location server, or an LMF.

In another example, the first set of UEs corresponds to a set of master UEs, and where the second UE corresponds to a slave UE.

FIG. 12 is a diagram 1200 illustrating an example of a hardware implementation for a network entity 1260 (e.g., a server). In one example, the network entity 1260 may be within the core network 120. The network entity 1260 may include at least one network processor 1212. The network processor(s) 1212 may include on-chip memory 1212′. In some aspects, the network entity 1260 may further include additional memory modules 1214. The network entity 1260 communicates via the network interface 1280 directly (e.g., backhaul link) or indirectly (e.g., through a RIC) with the CU 1202. The on-chip memory 1212′ and the additional memory modules 1214 may each be considered a computer-readable medium/memory. Each computer-readable medium/memory may be non-transitory. The network processor(s) 1212 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the SIB crowdsourcing component 199 may be configured to receive, from a first set of UEs, (1) information related to a SIB, (2) position information of the first set of UEs, and (3) time information of the first set of UEs, where the SIB is associated with a time transfer, where the information related to the SIB includes at least one of: an availability of the SIB, a type of the SIB, a transmitting interval of the SIB, a TUNC associated with the SIB, a time error associated with the SIB, or a reliability of a serving cell timing. The SIB crowdsourcing component 199 may also be configured to transmit, to a second UE based on the information related to the SIB, the position information, and the time information, a portion of the information related to the SIB based on a position of the second UE. The SIB crowdsourcing component 199 may be within the network processor(s) 1212. The SIB crowdsourcing component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1260 may include a variety of components configured for various functions. In one configuration, the network entity 1260 may include means for receiving, from a first set of UEs, (1) information related to a SIB, (2) position information of the first set of UEs, and (3) time information of the first set of UEs, where the SIB is associated with a time transfer, where the information related to the SIB includes at least one of: an availability of the SIB, a type of the SIB, a transmitting interval of the SIB, a TUNC associated with the SIB, a time error associated with the SIB, or a reliability of a serving cell timing. The network entity 1260 may further include means for transmitting, to a second UE based on the information related to the SIB, the position information, and the time information, a portion of the information related to the SIB based on a position of the second UE.

In one configuration, the SIB includes at least one of: a SIB8, a SIB9, or a SIB16.

In another configuration, the position information includes a GNSS position of the first set of UEs at which the information related to the SIB is collected by the first set of UEs, and where the time information includes a GNSS time of the first set of UEs at which the information related to the SIB is collected by the first set of UEs.

In another configuration, the type of the SIB includes at least one of a broadcast message or a dedicated message.

In another configuration, the TUNC associated with the SIB corresponds to a coverage radius or a propagation delay between each UE in the first set of UEs and a corresponding base station.

In another configuration, the network entity is a crowdsourcing server, a location server, or an LMF.

In another configuration, the first set of UEs corresponds to a set of master UEs, and where the second UE corresponds to a slave UE.

The means may be the SIB crowdsourcing component 199 of the network entity 1260 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: receiving, from a network entity, a portion of information related to a system information block (SIB) based on a position of the UE, wherein the SIB is associated with a time transfer, wherein the information related to the SIB includes at least one of: an availability of the SIB, a type of the SIB, a transmitting interval of the SIB, a time uncertainty (TUNC) associated with the SIB, a time error associated with the SIB, or a reliability of a serving cell timing; and decoding the SIB based on the portion of the information.

Aspect 2 is the method of aspect 1, wherein decoding the SIB based the portion of the information comprises: determining whether to decode the SIB based on at least one of: whether the SIB associated with the time transfer is available, whether the TUNC meets a TUNC threshold or a specification, whether the transmitting interval of the SIB meets an interval threshold, whether the time error is within a defined range, or whether the reliability of the serving cell timing is valid; and decoding the SIB based on the determination.

Aspect 3 is the method of aspect 1 or aspect 2, wherein the information related to the SIB includes the availability of the SIB for a plurality of cells, the method further comprising: scheduling a set of wake-up times for decoding SIBs for one or more cells in the plurality of cells based on the availability of the SIB for the plurality of cells.

Aspect 4 is the method of any of aspects 1 to 3, wherein the information related to the SIB includes the TUNC associated with the SIB, the method further comprising: adjusting a global navigation satellite system (GNSS) search window based on the TUNC associated with the SIB.

Aspect 5 is the method of any of aspects 1 to 4, wherein the information related to the SIB includes the availability of the SIB for a current cell and one or more neighboring cells, the method further comprising: decoding the SIB from a neighboring cell based on the SIB being available on the neighboring cell and unavailable on the current cell.

Aspect 6 is the method of any of aspects 1 to 5, wherein decoding the SIB from the neighboring cell comprises: decoding the SIB from the neighboring cell using of a secondary receiver chain.

Aspect 7 is the method of any of aspects 1 to 6, wherein the information related to the SIB includes the availability of the SIB for a set of carriers, the method further comprising: selecting a carrier in the set of carriers for decoding the SIB for the time transfer based on the SIB being available at the carrier.

Aspect 8 is the method of any of aspects 1 to 7, wherein the UE is a dual subscriber identity module (SIM) device with at least two subscriptions to at least two carriers, the method further comprising: enabling a dual SIM dual standby (DSDS) function for decoding the SIB.

Aspect 9 is the method of any of aspects 1 to 8, wherein the information related to the SIB includes the availability of the SIB on a plurality of networks, the method further comprising: selecting or switching to a network in the plurality of networks that supports the SIB for decoding the SIB, wherein the plurality of networks includes fifth generation (5G) new radio (NR) (5G NR) and fourth generation (4G) long term evolution (LTE) (4G LTE).

Aspect 10 is the method of any of aspects 1 to 9, wherein the SIB includes at least one of: a SIB type 8 (SIB8), a SIB type 9 (SIB9), or a SIB type 16 (SIB16).

Aspect 11 is the method of any of aspects 1 to 10, wherein the type of the SIB includes at least one of a broadcast message or a dedicated message.

Aspect 12 is the method of any of aspects 1 to 11, wherein the network entity is a crowdsourcing server, a location server, or a location management function (LMF).

Aspect 13 is an apparatus for wireless communication at a user equipment (UE), including: at least one memory; and at least one processor coupled to the at least one memory and, based at least in part on information stored in the at least one memory, the at least one processor, individually or in any combination, is configured to implement any of aspects 1 to 12.

Aspect 14 is the apparatus of aspect 13, further including at least one transceiver coupled to the at least one processor.

Aspect 15 is an apparatus for wireless communication at a user equipment (UE), including means for implementing any of aspects 1 to 12.

Aspect 16 is a computer-readable medium (e.g., a non-transitory computer-readable medium) storing computer executable code, where the code when executed by a processor causes the processor to implement any of aspects 1 to 12.

Aspect 17 is a method of wireless communication at a network entity, comprising: receiving, from a first set of user equipments (UEs), (1) information related to a system information block (SIB), (2) position information of the first set of UEs, and (3) time information of the first set of UEs, wherein the SIB is associated with a time transfer, wherein the information related to the SIB includes at least one of: an availability of the SIB, a type of the SIB, a transmitting interval of the SIB, a time uncertainty (TUNC) associated with the SIB, a time error associated with the SIB, or a reliability of a serving cell timing; and transmitting, to a second UE based on the information related to the SIB, the position information, and the time information, a portion of the information related to the SIB based on a position of the second UE.

Aspect 18 is the method of aspect 17, wherein the SIB includes at least one of: a SIB type 8 (SIB8), a SIB type 9 (SIB9), or a SIB type 16 (SIB16).

Aspect 19 is the method of aspect 17 or aspect 18, wherein the position information includes a global navigation satellite system (GNSS) position of the first set of UEs at which the information related to the SIB is collected by the first set of UEs, and wherein the time information includes a GNSS time of the first set of UEs at which the information related to the SIB is collected by the first set of UEs.

Aspect 20 is the method of any of aspects 17 to 19, wherein the type of the SIB includes at least one of a broadcast message or a dedicated message.

Aspect 21 is the method of any of aspects 17 to 20, wherein the TUNC associated with the SIB corresponds to a coverage radius or a propagation delay between each UE in the first set of UEs and a corresponding base station.

Aspect 22 is the method of any of aspects 17 to 21, wherein the network entity is a crowdsourcing server, a location server, or a location management function (LMF).

Aspect 23 is the method of any of aspects 17 to 22, wherein the first set of UEs corresponds to a set of master UEs, and wherein the second UE corresponds to a slave UE.

Aspect 24 is an apparatus for wireless communication at a network entity, including: at least one memory; and at least one processor coupled to the at least one memory and, based at least in part on information stored in the at least one memory, the at least one processor, individually or in any combination, is configured to implement any of aspects 17 to 23.

Aspect 25 is the apparatus of aspect 24, further including at least one transceiver or at least one network interface coupled to the at least one processor.

Aspect 26 is an apparatus for wireless communication at a network entity, including means for implementing any of aspects 17 to 23.

Aspect 27 is a computer-readable medium (e.g., a non-transitory computer-readable medium) storing computer executable code, where the code when executed by a processor causes the processor to implement any of aspects 17 to 23.

What is claimed is:

1. An apparatus for wireless communication at a user equipment (UE), comprising:
at least one memory;
at least one transceiver; and
at least one processor coupled to the at least one memory and the at least one transceiver, the at least one processor, individually or in any combination, is configured to:
receive, from a network entity via the at least one transceiver, a portion of information related to a system information block (SIB) based on a position of the UE, wherein the SIB is associated with a time transfer, wherein the information related to the SIB includes at least one of:
an availability of the SIB,
a type of the SIB,
a transmitting interval of the SIB,
a time uncertainty (TUNC) associated with the SIB,
a time error associated with the SIB, or
a reliability of a serving cell timing; and
decode the SIB based on the portion of the information.

2. The apparatus of claim 1, wherein to decode the SIB based the portion of the information, the at least one processor, individually or in any combination, is configured to:
determine whether to decode the SIB based on at least one of:
whether the SIB associated with the time transfer is available,
whether the TUNC meets a TUNC threshold or a specification,
whether the transmitting interval of the SIB meets an interval threshold,
whether the time error is within a defined range, or
whether the reliability of the serving cell timing is valid; and
decode the SIB based on the determination.

3. The apparatus of claim 1, wherein the information related to the SIB includes the availability of the SIB for a plurality of cells, the at least one processor, individually or in any combination, is further configured to:
schedule a set of wake-up times for decoding SIBs for one or more cells in the plurality of cells based on the availability of the SIB for the plurality of cells.

4. The apparatus of claim 1, wherein the information related to the SIB includes the TUNC associated with the SIB, the at least one processor, individually or in any combination, is further configured to:
adjust a global navigation satellite system (GNSS) search window based on the TUNC associated with the SIB.

5. The apparatus of claim 1, wherein the information related to the SIB includes the availability of the SIB for a current cell and one or more neighboring cells, the at least one processor, individually or in any combination, is further configured to:
decode the SIB from a neighboring cell based on the SIB being available on the neighboring cell and unavailable on the current cell.

6. The apparatus of claim 5, wherein to decode the SIB from the neighboring cell, the at least one processor, individually or in any combination, is further configured to:
decode the SIB from the neighboring cell using of a secondary receiver chain.

7. The apparatus of claim 1, wherein the information related to the SIB includes the availability of the SIB for a set of carriers, the at least one processor, individually or in any combination, is further configured to:
select a carrier in the set of carriers for decoding the SIB for the time transfer based on the SIB being available at the carrier.

8. The apparatus of claim 7, wherein the UE is a dual subscriber identity module (SIM) device with at least two subscriptions to at least two carriers, the at least one processor, individually or in any combination, is further configured to:
enable a dual SIM dual standby (DSDS) function for decoding the SIB.

9. The apparatus of claim 1, wherein the information related to the SIB includes the availability of the SIB on a plurality of networks, the at least one processor, individually or in any combination, is further configured to:
select or switch to a network in the plurality of networks that supports the SIB for decoding the SIB, wherein the plurality of networks includes fifth generation (5G) new radio (NR) (5G NR) and fourth generation (4G) long term evolution (LTE) (4G LTE).

10. The apparatus of claim 1, wherein the SIB includes at least one of: a SIB type 8 (SIB8), a SIB type 9 (SIB9), or a SIB type 16 (SIB16).

11. The apparatus of claim 1, wherein the type of the SIB includes at least one of a broadcast message or a dedicated message.

12. The apparatus of claim 1, wherein the network entity is a crowdsourcing server, a location server, or a location management function (LMF).

13. A method of wireless communication at a user equipment (UE), comprising:
receiving, from a network entity, a portion of information related to a system information block (SIB) based on a position of the UE, wherein the SIB is associated with a time transfer, wherein the information related to the SIB includes at least one of:
an availability of the SIB,
a type of the SIB,
a transmitting interval of the SIB,
a time uncertainty (TUNC) associated with the SIB,
a time error associated with the SIB, or
a reliability of a serving cell timing; and
decoding the SIB based on the portion of the information.

14. The method of claim 13, wherein decoding the SIB based the portion of the information comprises:
determining whether to decode the SIB based on at least one of:
whether the SIB associated with the time transfer is available,
whether the TUNC meets a TUNC threshold or a specification,
whether the transmitting interval of the SIB meets an interval threshold,
whether the time error is within a defined range, or
whether the reliability of the serving cell timing is valid; and
decoding the SIB based on the determination.

15. The method of claim 13, wherein the information related to the SIB includes the availability of the SIB for a plurality of cells, the method further comprising:
scheduling a set of wake-up times for decoding SIBs for one or more cells in the plurality of cells based on the availability of the SIB for the plurality of cells.

16. The method of claim 13, wherein the information related to the SIB includes the TUNC associated with the SIB, the method further comprising:
adjusting a global navigation satellite system (GNSS) search window based on the TUNC associated with the SIB.

17. The method of claim 13, wherein the information related to the SIB includes the availability of the SIB for a current cell and one or more neighboring cells, the method further comprising:
decoding the SIB from a neighboring cell based on the SIB being available on the neighboring cell and unavailable on the current cell.

18. The method of claim 17, wherein decoding the SIB from the neighboring cell comprises:
decoding the SIB from the neighboring cell using of a secondary receiver chain.

19. The method of claim 13, wherein the information related to the SIB includes the availability of the SIB for a set of carriers, the method further comprising:
selecting a carrier in the set of carriers for decoding the SIB for the time transfer based on the SIB being available at the carrier.

20. The method of claim 19, wherein the UE is a dual subscriber identity module (SIM) device with at least two subscriptions to at least two carriers, the method further comprising:
enabling a dual SIM dual standby (DSDS) function for decoding the SIB.

21. The method of claim 13, wherein the information related to the SIB includes the availability of the SIB on a plurality of networks, the method further comprising:
selecting or switching to a network in the plurality of networks that supports the SIB for decoding the SIB, wherein the plurality of networks includes fifth generation (5G) new radio (NR) (5G NR) and fourth generation (4G) long term evolution (LTE) (4G LTE).

22. An apparatus for wireless communication at a network entity, comprising:
at least one memory;
at least one network interface; and
at least one processor coupled to the at least one memory and the at least one network interface, the at least one processor, individually or in any combination, is configured to:
receive, from a first set of user equipments (UEs) via the at least one network interface, (1) information related to a system information block (SIB), (2) position information of the first set of UEs, and (3) time information of the first set of UEs, wherein the SIB is associated with a time transfer, wherein the information related to the SIB includes at least one of:
an availability of the SIB,
a type of the SIB,
a transmitting interval of the SIB,
a time uncertainty (TUNC) associated with the SIB,
a time error associated with the SIB, or
a reliability of a serving cell timing; and
transmit, to a second UE via the at least one network interface based on the information related to the SIB, the position information, and the time information, a portion of the information related to the SIB based on a position of the second UE.

23. The apparatus of claim 22, wherein the SIB includes at least one of: a SIB type 8 (SIB8), a SIB type 9 (SIB9), or a SIB type 16 (SIB16).

24. The apparatus of claim 22, wherein the position information includes a global navigation satellite system (GNSS) position of the first set of UEs at which the information related to the SIB is collected by the first set of UEs, and wherein the time information includes a GNSS time of the first set of UEs at which the information related to the SIB is collected by the first set of UEs.

25. The apparatus of claim 22, wherein the type of the SIB includes at least one of a broadcast message or a dedicated message.

26. The apparatus of claim 22, wherein the TUNC associated with the SIB corresponds to a coverage radius or a propagation delay between each UE in the first set of UEs and a corresponding base station.

27. The apparatus of claim 22, wherein the network entity is a crowdsourcing server, a location server, or a location management function (LMF).

28. The apparatus of claim 22, wherein the first set of UEs corresponds to a set of master UEs, and wherein the second UE corresponds to a slave UE.

29. A method of wireless communication at a network entity, comprising:
receiving, from a first set of user equipments (UEs), (1) information related to a system information block (SIB), (2) position information of the first set of UEs, and (3) time information of the first set of UEs, wherein the SIB is associated with a time transfer, wherein the information related to the SIB includes at least one of:
an availability of the SIB,
a type of the SIB,
a transmitting interval of the SIB,
a time uncertainty (TUNC) associated with the SIB,
a time error associated with the SIB, or
a reliability of a serving cell timing; and
transmitting, to a second UE based on the information related to the SIB, the position information, and the time information, a portion of the information related to the SIB based on a position of the second UE.

30. The method of claim 29, wherein the SIB includes at least one of: a SIB type 8 (SIB8), a SIB type 9 (SIB9), or a SIB type 16 (SIB16).
